(19) United States
(12) Patent Application Publication
(10) Pub. No.: US 2016/0127501 A1
(43) Pub. Date: May 5, 2016

(54) HINT-BASED IDENTIFICATION SCHEME FOR A NETWORK

(71) Applicant: FRIENDSY, INC., Morganville, NJ (US)

(72) Inventors: Vaidhyanath Murti, Morganville, NJ (US); Michael Pinsky, New York, NY (US)

(73) Assignee: FRIENDSY, INC, Morganville, NJ (US)

(21) Appl. No.: 14/931,097

(22) Filed: Nov. 3, 2015

Related U.S. Application Data
(60) Provisional application No. 62/074,424, filed on Nov. 3, 2014.

(51) Int. Cl. H04L 29/08

(52) U.S. Cl. CPC H04L 67/306; H04L 67/10

(57) ABSTRACT

An interest vector directed from a source profile to a target profile, and hints associated with the interest vector, are received. A profile filter is generated based on the hints. Profiles of a network are filtered, creating a set of profiles, each having attributes matching the hints. A first number of profiles in the set of profiles is calculated. Second hints are received, based on the first number, the second hints associated with the interest vector. A second profile filter is generated based on the second hints, and used to filter the profiles of the network, creating a second set of profiles. A second number of profiles in the second set of profiles is calculated. An interest alert is generated based on the second number, the interest alert including data sufficient to directly or indirectly identify the source profile and configured to notify the target profile about the interest vector.

### CROSS-REFERENCE TO RELATED APPLICATIONS

The present application claims the benefit of U.S. Provisional Patent Application Ser. No. 62/074,424, filed Nov. 3, 2014 and entitled “Hint-Based Identification Scheme for a Social Network,” which is incorporated herein by reference.

### BRIEF DESCRIPTION OF THE DRAWINGS

FIG. 1 shows a block diagram of an example of an environment capable of providing a hint-based identification scheme for a network.

FIG. 2 shows a block diagram of a flowchart of an example method of operation of an environment capable of providing a hint-based identification scheme for a network.

FIG. 3 shows a block diagram of a flowchart of an example method of user registration for an environment capable of providing a hint-based identification scheme for a network.

FIG. 4 depicts a block diagram of an example of a hint provisioning system.

FIG. 5 shows a block diagram of a flowchart of an example method of operation of a hint provisioning system.

FIG. 6 shows a block diagram of an example profile set creation system.

FIG. 7 shows a block diagram of a flowchart of an example method of operation of a profile set creation system.

FIG. 8 shows a block diagram of an example matching system.

FIG. 9 shows a block diagram of a flowchart of an example method of operation of a matching system.

FIGS. 10-14 show example social network browser windows.

FIG. 15 shows an example of an environment capable of providing a hint-based identification scheme for a network.

FIG. 16 shows a block diagram of an example of a computer system.

### DETAILED DESCRIPTION

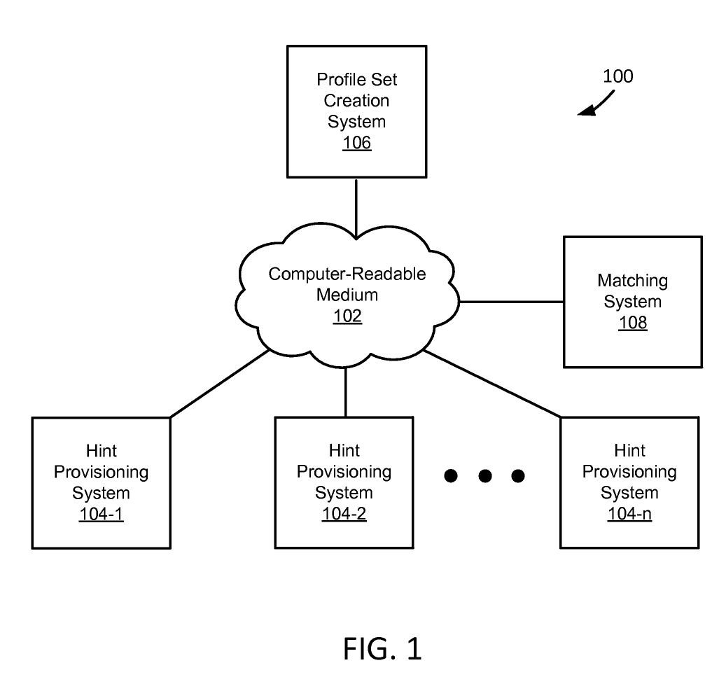

FIG. 1 shows a block diagram of an example of an environment 100 capable of providing a hint-based identification scheme for a network (e.g., social network, professional network, private network, etc.). Generally, the environment 100 can allow users to indicate interest in target profiles of the network. More specifically, the environment 100 can provide hints to target profiles which can allow, for example, users to provide details about themselves without revealing their identities. The environment 100 includes a computer-readable medium 102, hint provisioning systems 104-1 to 104-n (collectively, the hint provisioning systems 104), a profile set creation system 106, and a matching system 108.

In the example of FIG. 1, the hint provisioning systems 104, the profile set creation system 106, and the matching system 108, are coupled to the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

In the example of FIG. 1, the computer-readable medium 102 can include a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 102 broadly includes, as understood from relevant context, anything from a minimalist coupling of the components illustrated in the example of FIG. 1, to every component of the Internet and networks coupled to the Internet. In some implementations, the computer-readable medium 102 is administered by a service provider, such as an Internet Service Provider (ISP).

In various implementations, the computer-readable medium 102 can include technologies such as Ethernet, 802.11, worldwide interoperability for microwave access (WiMAX), 3G, 4G, CDMA, GSM, LTE, digital subscriber line (DSL), etc. The computer-readable medium 102 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over computer-readable medium 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the computer-readable medium 102 can include a wired network using wires for at least some communications. In some implementations the computer-readable medium 102 comprises a wireless network. A “wireless network,” as used in this paper can include any computer network communicating at least in part without the use of electrical wires. In various implementations, the computer-readable medium 102 includes technologies such as Ethernet, 802.11, worldwide interoperability for microwave access (WiMAX), 3G, 4G, CDMA, GSM, LTE, digital subscriber line (DSL), etc. The computer-readable medium 102 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the computer-readable medium 102 is compatible with the 802.11 protocols specified by the Institute of Electrical and Electronics Engineers (IEEE). In a specific implementation, the wireless network of the network 130 is compatible with the 802.3 protocols specified by the IEEE. In some implementations, IEEE 802.3 compatible protocols of the computer-readable medium 102 can include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the computer-readable medium 102.

The computer-readable medium 102, the hint provisioning systems 104, the profile set creation system 106, the matching system 108, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In the example of FIG. 1, the hint provisioning systems 104 function to allow users to interact with a network. For example, the hint provisioning systems 104 can be mobile devices. In a specific implementation, the hint provisioning systems 104 can function to allow users to indicate interest in target profiles associated with the network, provide hints associated with a particular indication of interest, receive interest alerts, respond to interest alerts, and otherwise interact with the other systems of the environment 100.

As used in this paper, an indication of interest can be represented as an interest vector. An interest vector includes an origin point, a terminal point, and a vector “magnitude.” In a specific implementation, an origin point is a source profile identifier (e.g., a profile associated with a user indicating interest in a target profile), the terminal point is a target profile identifier, and the vector “magnitude” represents a level of interest. Magnitude is in quotes because it is not strictly required that the “magnitude” of the vector represent a scalable value, such as a number. Rather, the “magnitude” can include values for which a straight-forward numerical comparison is not possible, such as, for example, walking on the beach as opposed to having dinner. Of course, the vector magnitude can also be scalable (e.g., different weights associated with different interest levels), or otherwise. For example, the vector magnitude can indicate alternative interest levels without associating weights with the different interest levels. Accordingly, in a non-scalable vector magnitude example, an interest level of “coffee,” and an interest level of “friend,” are not weighted to indicate that “friend” is associated with a higher or lower interest level than “coffee.” Rather, the magnitude vector indicates the different levels are alternatives.

In the example of FIG. 1, the hint provisioning systems 104 can provide hints based on profile attributes associated with a particular user and the particular user's level of interest in a target profile. For example, the profile attributes can include geographic attributes, demographic attributes, psychographic attributes, and/or behavioristic attributes, and the level of interest can include friend, date, hookup, sex, and/or coffee, just to name a few. Accordingly, for example, the profile attributes can include a gender of the user, a school attended by the user, and/or a class year of the user. In a specific implementation, the profile attributes can include tags, as discussed further below. The hints can be based on profile attributes selected by the user, and/or the hints can be based on a predetermined set of profile attributes (e.g., gender, school, graduation year, etc.) without requiring input from the user.

In a specific implementation, a user can select one or more profile attributes as “private,” and/or “public.” Public profile attributes can be included in a publicly displayed profile, while private profile attributes are not included in a publicly displayed profile, and can only be viewed by the user. In various implementations, private profile attributes can be included as hints, e.g., allowing users to provide details about themselves which would otherwise be unavailable.

In the example of FIG. 1, the hint provisioning systems 104 function to update hints. For example, if the hints are initially too specific, e.g., indicating the user's identity may be compromised, the associated hint provisioning system 104 can update the hints to include less detail. Conversely, if the hints are too generic, e.g., indicating a decreased likelihood of a positive response from the target profile, the associated hint provisioning system 104 can update the hints to include additional detail.

In a specific implementation, the hint provisioning systems 104 can update hints based on user input, e.g., at or near a time the user indicated interest in the target profile, and/or the hint provisioning systems 104 can update hints automatically, e.g., without receiving input from the user. For example, the hint provisioning systems 104 can update the hints until a predetermined level of hint specificity is achieved, e.g., a predetermined number of profiles match the hints.

In a specific implementation, the interest alerts can function to notify a target profile of an associated indication of interest. For example, each alert can include some or all of the hints associated with the indication of interest, as discussed further below.

In the example of FIG. 1, the profile set creation system 106 functions to create, read, update and/or delete profiles and/or sets of profiles. A profile can include, for example, some or all of the profile attributes discussed above, along with other related data, e.g., pictures, photographs, account credentials, etc. In various embodiments, each user in a network can be associated with a unique profile. A profile set can include, for example, some or all of the profiles that match the hints associated with a particular indication of interest.

In the example of FIG. 1, the profile set creation system 106 functions to create, read, update and/or delete profile filters. For example, a profile filter can be based on some or all of the profile attributes of a user associated with a particular indication of interest. In a specific implementation, the profile filters can be based on some or all of the hints associated with a particular indication of interest. The profile set creation system 106 can apply the filters, for example, to determine a number of profiles which match the hints associated with a particular indication of interest. Similarly, the profile set creation system 106 can create a new filter, or update an existing filter, e.g., to reduce or increase the number of profiles matching the hints associated with a particular indication of interest. In a specific implementation, the profile set creation system 106 can automatically generate new filters, and/or update existing filters, to achieve a predetermined number of profile matches, e.g., based on rules executing on the profile set creation system.

In the example of FIG. 1, the matching system 108 functions to determine whether a target profile matches a profile associated with the user that indicated interest in the target profile. If a match is confirmed, the matching system 108 can notify the target profile and/or the user of the confirmed match. In a specific implementation, the matching system 108 can determine a confirmed match if the profile associated with the user previously received the same indicated level of interest from a user associated with the target profile. For example, if user A indicates a “date” interest in target profile B, a match exists if a user associated with target profile B previously indicated a “date” interest in a profile associated with user A.

In a specific implementation, the matching system 108 can function to determine a match based on interest vectors. For example, a match can be determined if a first interest vector and a second interest vector have the same, or substantially similar, vector magnitudes, and the first interest vector has an origin point that matches a terminal point of the second vector, and a terminal point that matches the origin point of the second vector. In this way, a match is found by subtracting a first interest vector from a second interest vector. Depending upon implementation-specific factors, it may also be possible to subtract one interest vector from another and determine a lowest-common-denominator match if the subtraction yields a remainder. For example, if a first interest vector AB has a magnitude of ‘3’ and a second interest vector BA has a magnitude of ‘5,’ the system could indicate a match of magnitude ‘3’ (the lesser of the two magnitudes). This may only be meaningful in a context in which vector magnitude actually has scalable values.

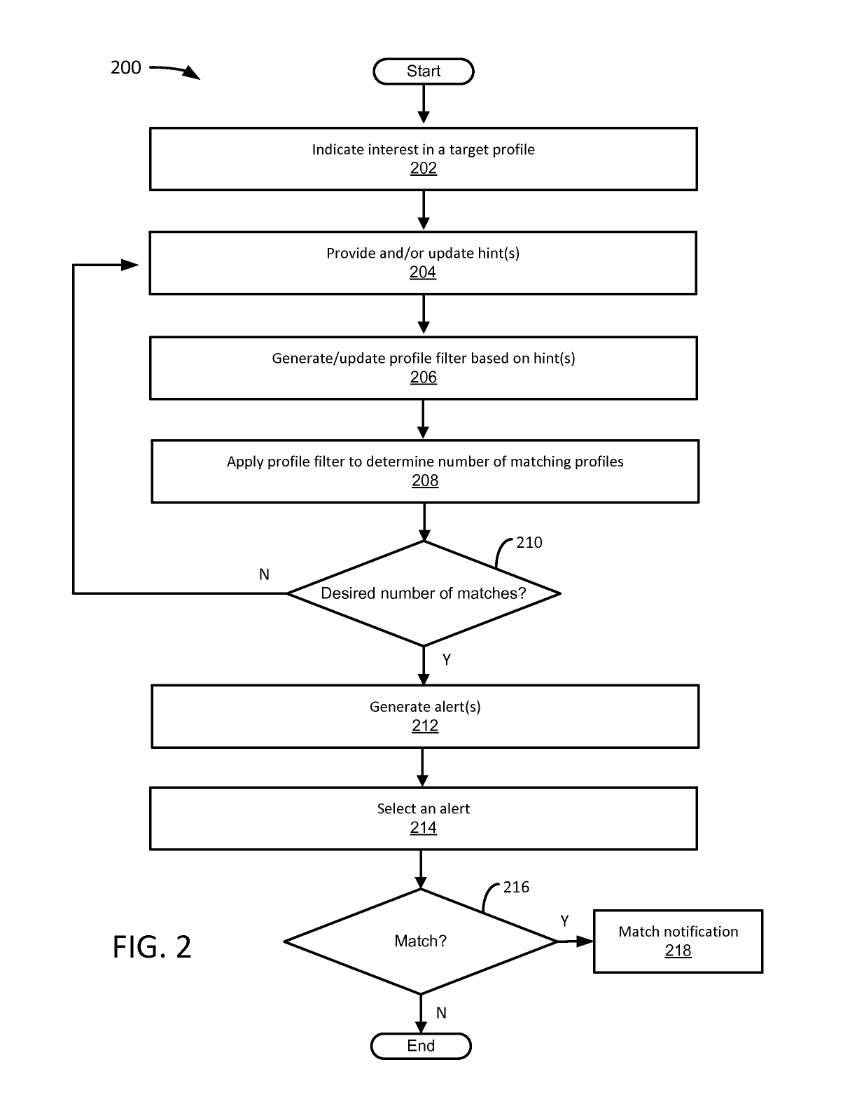

FIG. 2 shows a block diagram 200 of a flowchart of an example method of operation of an environment capable of providing a hint-based identification scheme for a network.

In step 202, a user, interacting with a first hint provisioning system, can indicate an interest in a target profile associated with a network. For example, the first hint provisioning system can display a GUI presenting a plurality of different profiles, e.g., showing a profile picture and/or other profile attributes. The user can indicate an interest in a target profile, for example, by selecting a particular one of the different profiles and indicating a level of interest in the target profile.

In step 204, the first hint provisioning system can generate and/or update one or more hints based on one or more profile attributes associated with the user. Further, the first hint provisioning system can associate the one or more hints with the indication of interest in the target profile. In various implementations, the hints can be based on profile attributes selected by the user and/or based on a predetermined set of profile attributes.

In step 206, a profile set creation system can receive the hints from the first hint provisioning system via a computer-readable medium. Further, the profile set creation system can generate a profile filter based on some or all of the hints associated with the indication of interest. The profile set creation system can apply the profile filter to some or all of the profiles of the network to determine a number of profiles associated with the network which match, or substantially match, some or all of the hints associated with the indication of interest in the target profile (step 208). The profile set creation system can transmit the number of matching profiles to the first hint provisioning system via the computer-readable medium.

In step 210, the first hint provisioning system can display the number of matches to the user, and the user can determine if the number of matching profiles corresponds to a desired number of matches. If the user determines there are too many or too few matches, the user, interacting with the hint provisioning system, can update the hints associated with the indication of interest (step 204).

In addition to, or instead of, the user determining whether the number of matches corresponds to a desired number of matches, the first hint provisioning system can make the determination. For example, the hint provisioning system can compare the number of matches to a predetermined value (e.g., 50) and/or a predetermined value range (e.g., 50-100). The determined value and/or value range can be defined by the user and/or the hint provisioning system (e.g., based on a rule). If the number of matches does not equal the predetermined value and/or does not fall within the predetermined value range, the first hint provisioning system can update the hints associated with the indication of interest (return to step 204).

In various implementations, the steps 204-210 can be repeated until a desired number of matches is reached.

In step 212, the profile set creation system can generate interest alert(s). In various implementations, an interest alert can be based on the hints associated with the indication of interest in the target profile. In a specific implementation, the profile set creation system can associate a batch of profiles (e.g., 10 profiles) with an alert. For example, each alert can include the profile, or portion of the profile, associated with the user that indicated interest in the target profile, along with other profiles, or portions of profiles, that may be of interest to the target profile, e.g., based on match preferences associated with the target profile.

In a specific implementation, each alert can include at least one profile, or portion thereof, that is a mutual match with the target profile, e.g., based on the match preferences associated with the target profile. The profile set creation system can transmit the alert(s) to a second hint provisioning system associated with the target profile, e.g., when the alert(s) are created and/or when a second user associated with the target profile logs in to the network. In a specific implementation, the second hint provisioning system can provide additional hints and/or include an automated mechanism for improving the likelihood of a successful match.

In step 214, the second hint provisioning system can receive the alert(s) from the profile set creation system via the computer-readable medium. The second user can select, e.g., using a GUI displayed by the second hint provisioning system, to select one or more of the alerts. In step 216, the second hint provisioning system, in response to an interest alert selection, can generate and transmit a message based on the alert to a matching system. The matching system can determine if the target profile matches a profile associated with the selected alert. If a match exists, the matching system can notify the second user associated with the target profile and/or a user associated with the alert (step 218).

In a specific implementation, in response to an interest alert selection, the second hint provisioning system can display each of the batch profiles. The second user can select one or more of the profiles, and the matching system can determine if a match exists with that profile, and/or the second user can indicate interest in the selected profile (i.e., return to step 202 and repeat steps 202-218 for the second user).

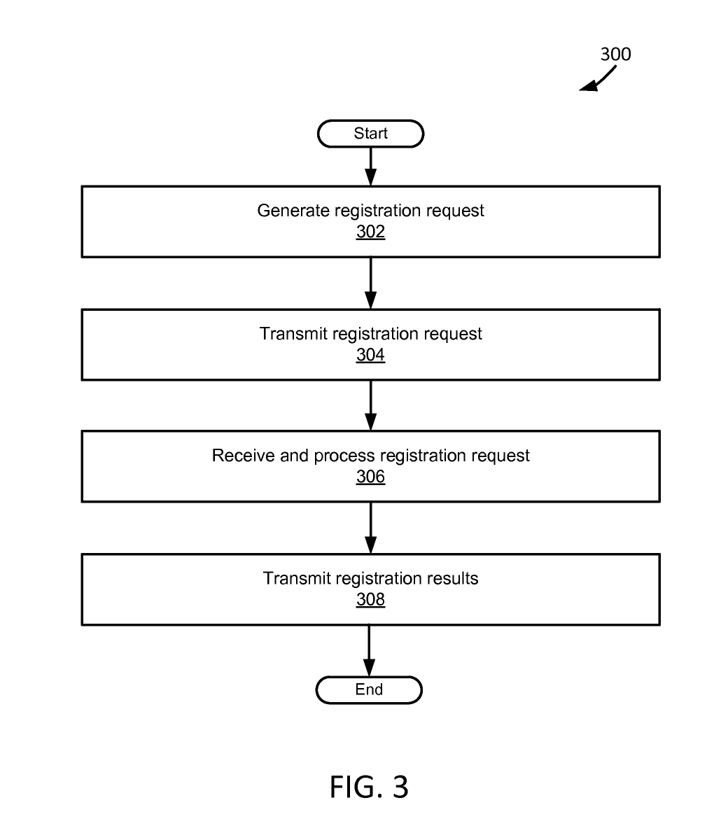

FIG. 3 shows a block diagram 300 of a flowchart of an example method of user registration for an environment capable of providing a hint-based identification scheme for a network.

In step 302, a hint provisioning system, in response to input received from a user, generates a registration request to join a network. For example, the network can be limited to a particular group or organization (e.g., a particular college or university campus) or a particular geographic region (e.g., a particular city or town). In a specific implementation, the hint provisioning system can prompt a user to enter information for generating a profile associated with the user, and the registration request can include that information. For example, the information can include profile attributes.

In step 304, the hint provisioning system can transmit the registration request to a profile set creation system via a computer-readable medium. In various implementations, prior to transmitting the registration request, the hint provisioning system can verify a user's eligibility to join a social network based on the information included in the registration request, such as a user's email address. For example, the hint provisioning system can require a specific type of email domain, such as “.edu,” “.gov,” and/or a domain specific to a particular group or organization (e.g., “harvard.edu”).

In step 306, the profile set creation system receives the registration request via the computer-readable medium, and processes the registration request. For example, the profile set creation system can confirm eligibility of the user identified in the registration to join the network, and if eligible, generate a profile based on the information included in the registration request. In step 308, the profile set creation system can notify the hint provisioning system of the results of the registration processing. For example, the profile set creation system can transmit a data message to the hint provisioning system via the computer-readable medium confirming or denying the registration request.

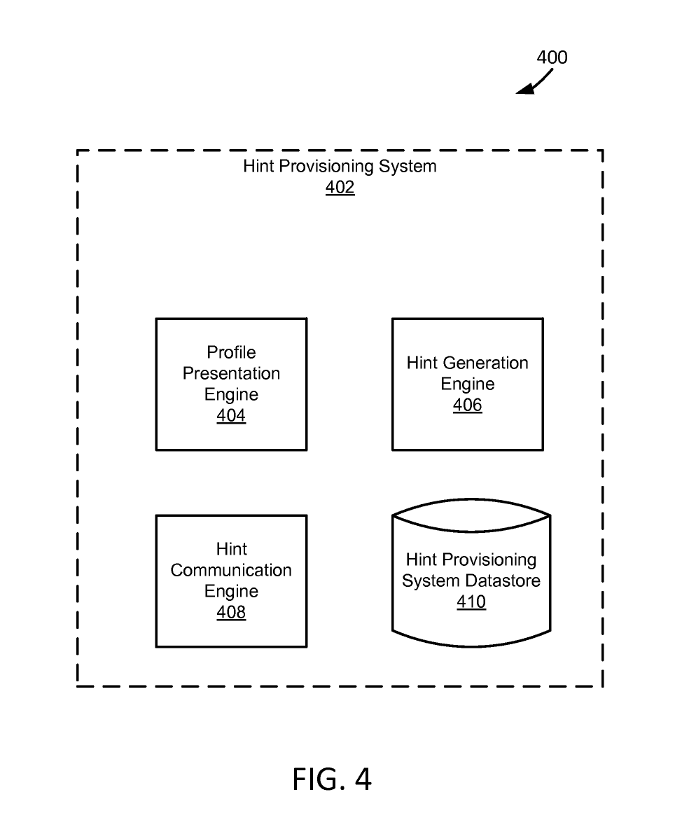

FIG. 4 depicts a diagram 400 of an example of a hint provisioning system 402. The example hint provisioning system 402 includes a profile presentation engine 404, a hint generation engine 406, a hint communication engine 408, and a hint provisioning system datastore 410.

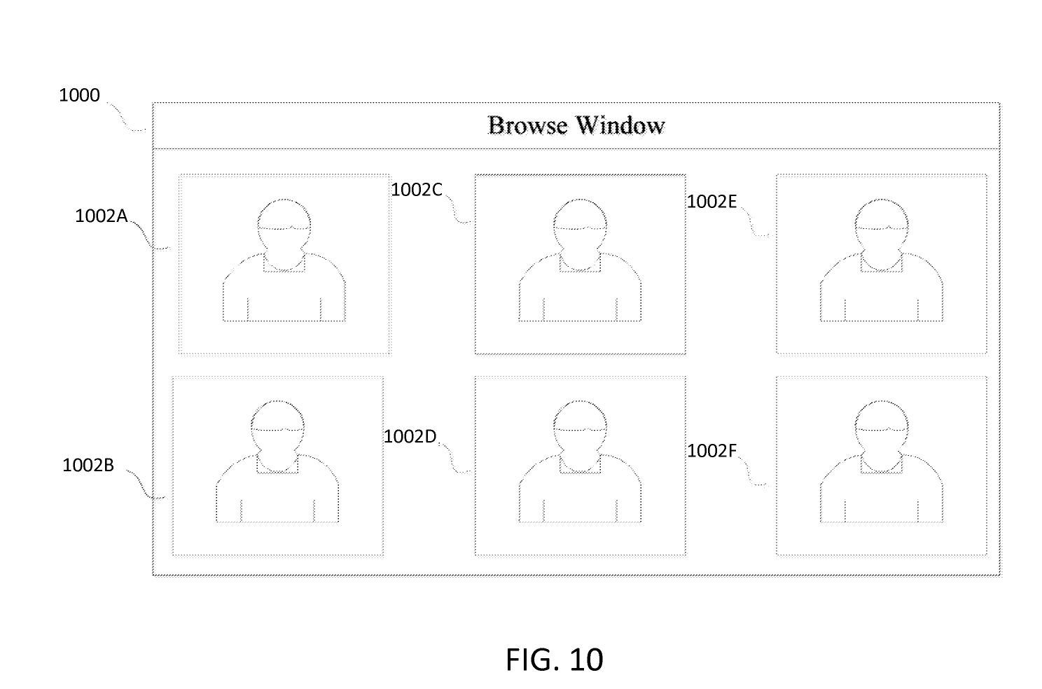

In the example of FIG. 4, the profile presentation engine 404 functions to display one or more profiles, allow users to indicate interest in target profiles, edit profiles, and otherwise interact with a network. Example displays which can be rendered by the profile presentation engine 404 are shown in FIGS. 10-14.

In the example of FIG. 4, the hint generation engine 406 functions to generate and update hints. As discussed elsewhere in this paper, hints can be based on one or more profile attributes associated with a user indicating interest in a target profile. In a specific implementation, the hint generation engine 406 can define a threshold match value and/or value range (collectively, threshold match value). The hint generation engine 406 can compare a number of profiles which match a set of hints to the threshold match value to determine whether to update the set of hints, and/or generate a new set of hints. For example, if the number of matches do not satisfy the threshold match value, the hint generation engine 406 can manually (e.g., based on user input) and/or automatically (e.g., without user input) update the hints to include a different set hints. For example, the hint generation engine 406 can update the hints by adding and/or removing hints until the threshold match value is satisfied.

In the example of FIG. 4, the hint communication engine 408 functions to send requests to and receive data from one or a plurality of systems. The hint communication engine 408 can send requests to and receive data from a system through a network or a portion of a network. Depending upon implementation-specific or other considerations, the hint communication engine 408 can send requests and receive data through a connection, all or a portion of which can be a wireless connection. The hint communication engine 408 can request and receive a set of profiles, or a number of profiles, matching a particular set of hints, receive a set of profiles, or a number of profiles, matching a particular set of hints. Received data can be stored in the hint datastore 410.

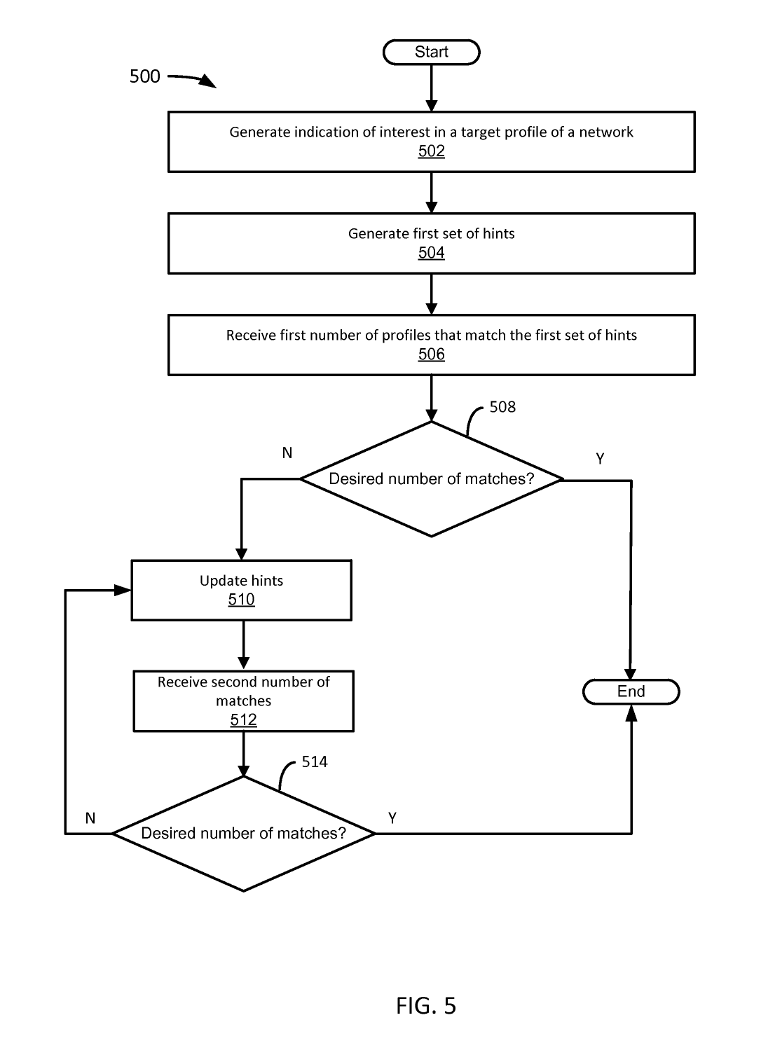

FIG. 5 shows a block diagram 500 of a flowchart of an example method of operation of a hint provisioning system.

In step 502, a hint provisioning system can generate an indication of interest in a target profile of a plurality of profiles of a network, the indication of interest generated based on a selection of the target profile by a user. For example, a profile presentation engine can display a plurality of profiles. The user can select the target profile by clicking on one of the plurality of profiles, and/or select a particular level of interest (e.g., friend, date, hookup, coffee, etc.) in the target profile.

In step 504, the hint provisioning system can generate a first set of hints associated with the indication of interest. For example, a hint generation engine can generate the first set of hints based on one or more profile attributes associated with the user. The profile attributes can be selected by the user, and/or selected by the hint generation engine, e.g., based on a predetermined set of hints and/or profile attributes.

In step 506, the hint provisioning system can receive a first profile match number, the first profile match number identifying a first number of profiles of the network having profile attributes matching the first set of hints. For example, a hint communication engine can receive the number of profiles. In step 508, the hint provisioning system, and/or a user interacting with the hint provisioning system, can determine if a desired number of matches has been achieved, e.g., indicating that the hints are neither too specific or generic. In a specific implementation, the hint generation engine can compare the first profile match number with a threshold match value. If the first profile match number is different from the threshold match value, the hint provisioning system can generate a second set of hints associated with the indication of interest (step 510).

In step 512, the hint provisioning system can receive a second profile match number, the second profile match number identifying a second number of profiles of the network having profile attributes matching the second set of hints. For example, the hint communication engine can receive the second profile match number. In step 514, the hint provisioning system can compare the second profile match number with the threshold match value. For example, the hint generation engine can perform the comparison, e.g., with or without user input. If the second profile match number is different from the threshold match value, the hint provisioning system can generate a second set of hints associated with the indication of interest.

In various implementations, some or all of the steps 506-514 can be repeated until the hint provisioning system receives a profile match number that satisfies the threshold match value.

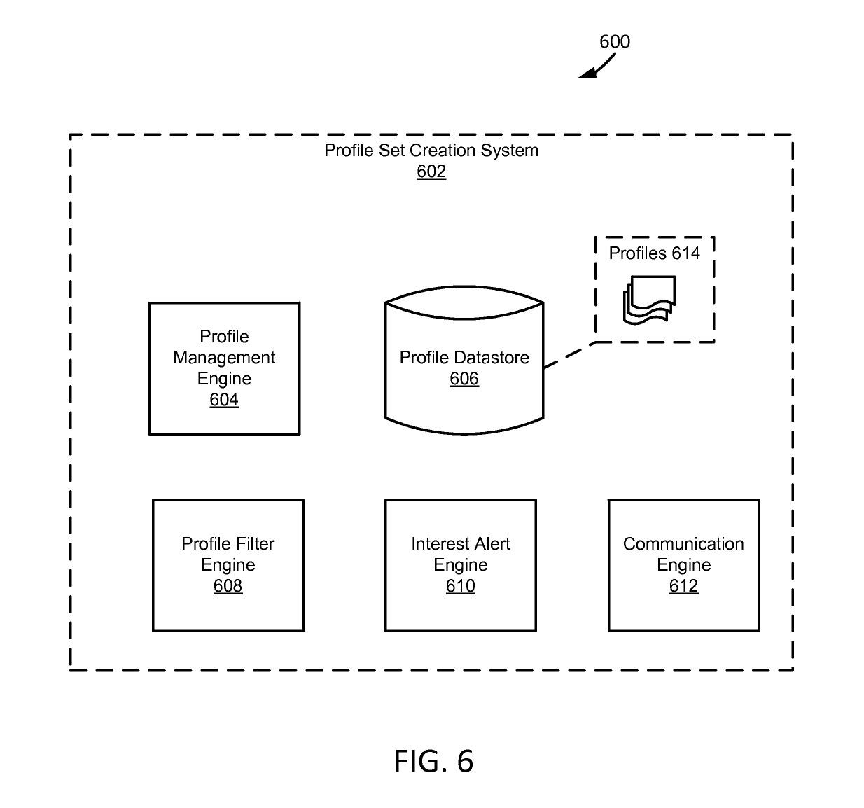

FIG. 6 shows a block diagram 600 of an example profile set creation system 602. The example profile set creation system 602 includes a profile management engine 604, a profile datastore 606, a profile filter engine 608, an interest alert engine 610, and a communication engine 612.

In the example of FIG. 6, the profile management engine 604 is configured to create, read, update, delete, or otherwise access profiles 614 stored in the profile datastore 606. The profile management engine 604 can perform any of these operations either manually (e.g., by an administrator interacting with a GUI) or automatically (e.g., in response to a request from a hint provisioning system to create, read, update, and/or delete a profile).

In the example of FIG. 6, the profiles 614 can store a variety of public and/or private data. In various implementations, the data can include profile attributes, account credential information (e.g., username/password), and other related data. In a specific implementation, the profile attributes can include geographic attributes, demographic attributes, psychographic attributes, and/or behavioristic attributes. Accordingly, example profile attributes can include any of the following:
Profile Identifier: Identifier that uniquely identifies the profile.
Gender: Gender of the member, e.g., female, male, transgender, etc.
Class year: Graduating class year of the member, e.g., 2006.
School: School attended by the member, e.g., Princeton University.
Tags: Tags selected by the member (see below).
Name: First, middle, and/or last name of the user.
Age: Age of the member, e.g., as specified by the member or determined based on a date of birth provided by the member.
Geographic location: A current location of the member, e.g., as determined by a location service and/or specified by the member.
Match preferences: Profile attributes and interest level(s) the user is seeking in a match, e.g., “female,” “date,” etc.
Groups: Groups associated with the member. In a specific implementation, groups are restricted to verified involvements, e.g., a verified member of an academic department (e.g., history.)
Departments: Departments associated with the member. In a specific implementation, the departments can be school departments (e.g., Computer Science).
Matches: Confirmed profile matches within the network.
Public/Private Attributes: A list of profile attributes the user has selected as either public or private.
Other interests: Other interests specified by the member, e.g., sports, politics, religion, etc.

In a specific implementation, tags can allow users to provide more detail about themselves and/or interests. Tags, along with other profile attributes, can be included in indication of interests, e.g., as hints, and/or displayed as part of profiles. In various implementations, tags can include any of the following:

| | | |
|---|---|---|
| party animal | tailgate legend | Heisenberg |
| sorority sis | underachiever | frat bro |
| theater | wine lover | film fanatic |
| intramural | varsity | club sports |
| dance machine | pong champ | student gov |
| bookworm | writer | sports buff |
| econ | pre-law | GDI |
| pre-med | coffee addict | foodie |
| a cappella | literally drunk all the time | early bird |
| musician | chill | hacker |
| night owl | politics | english |
| must love dogs | mathlete | history |
| feminist | comic relief | marketing |
| psych | philosophy | fashionista |
| business | int'l studies | health nut |
| engineer | ugg boots/north face | nursing |
| education | Knope 2012 | hippie at heart |
| finance | Netflix and chill | activist |

420

In the example of FIG. 6, the profile filter engine 608 functions to generate (i.e., create, read, update, and/or delete) and apply profile filters to profiles of a network. For example, the profile filter engine 608 can generate a profile filter based on hints associated with a particular indication of interest, and apply the profile filter to the profiles 614 stored in the profile datastore 606 to determine a number of profiles which match the hints. New filters can be created, or existing profile filters can be updated, until a desired number of matches is achieved. For example, if a particular profile filter is generated based on a first set of hints that results in too many, or too few, matches, the profile filter engine 608 can update the particular filter, and/or generate a new filter, based on a different set of hints. This process can be repeated until the desired number of matching profiles is reached.

In a specific implementation, the profile filter engine 608 can define a notification threshold value (e.g., 50) of matching profiles that needs to be satisfied in order for the target profile to be notified of the associated indication of interest. The notification threshold value can be based on user input, and/or automatically generated, e.g., based on historical information associated with prior successful matches. For example, if a profile filter results in a greater or lesser number of matching profiles than the notification threshold value, the profile filter engine 608 can prevent the alert engine 608 from notifying the target profile of the indication of interest, request a different set of hints, and/or require authorization from the user to provide the indication of interest to the target profile.

In a specific implementation, the profile filter engine 608 can recommend a profile filter which can satisfy the notification threshold value. For example, the profile filter engine 608 can select a set of profile attributes associated with the user, generate a filter based on those selected profile attributes, and apply the filter to the profiles 614. If the resulting number of profile matches exceeds the threshold notification threshold value, the filter engine 608 can update the filter based on additional profile attributes. Similarly, if the resulting number of profile matches is below the notification threshold value, the filter engine 608 can remove one or more of the profile attributes and update the filter with the reduced set of profile attributes. This process can be repeated until the threshold notification value is satisfied.

In the example of FIG. 6, the interest alert engine 610 generates alerts to notify target profiles of associated indications of interest. The interest alert engine 610 can generate an alert based on some or all of the hints associated with an indication of interest. For example, an alert can indicate “a girl in the class of 2019 from Princeton wants to go on a date with you.” In a specific implementation, the interest alert engine 610 can only generate an alert to target profile if the notification threshold value is satisfied.

In a specific implementation, the interest alert engine 610 can associate a batch of a predetermined number of profiles (e.g., 10) with an alert. For example, each alert can include the profile, or portion of the profile, associated with the user that indicated interest in the target profile, along with other profiles, or portions of profiles, that may be of interest to the target profile, e.g., based on match preferences associated with the target profile. This can allow, for example, a target user associated with the target profile to view the profile associated with the interested user without revealing the interested user's identity. In a specific implementation, the interest alert engine 610 can include at least one profile, or portion thereof, that is a mutual match with the target profile, e.g., based on the match preferences associated with the target profile.

In the example of FIG. 6, the communication engine 612 functions to send requests to and receive data from one or a plurality of systems. The communication engine 612 can send requests to and receive data from a system through a network or a portion of a network. Depending upon implementation-specific or other considerations, the communication engine 612 can send requests and receive data through a connection, all or a portion of which can be a wireless connection. The communication engine 612 can request and receive hints, indications of interest in a target profile, user registration and/or profile update requests, and so forth. Received data can be stored in the profile datastore 612, or elsewhere on the profile set creation system 602, such as another datastore (e.g., a cache, and/or a buffer).

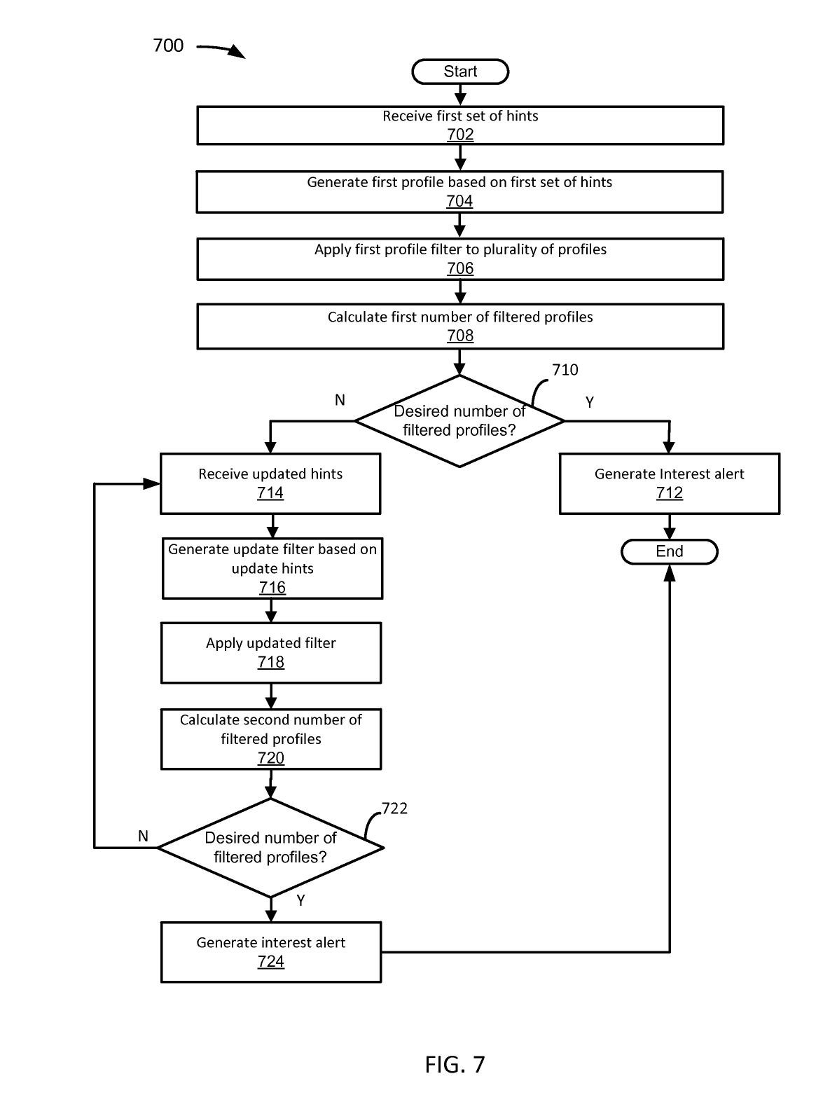

FIG. 7 shows a block diagram 700 of a flowchart of an example method of operation of a profile set creation system.

In step 702, a profile set creation system receives an indication of interest in a target profile of the network and a first set of hints associated with the indication of interest. The indication of interest and the first set of hints can be received from a hint provisioning system. For example, a communication engine can receive the indication of interest and the first set of hints.

In step 704, the profile set creation system generates a first profile filter based on the first set of hints. For example, a profile filter engine can generate the first profile filter. In step 706, the profile set creation system can filter the plurality of profiles using the first profile filter, which can create a first set of profiles, each of which have profile attributes matching the first set of hints. For example, the profile filter engine can filter the profiles.

In step 708, the profile set creation system calculates a first number of profiles in the first set of profiles. For example, the profile filter engine can calculate the number of profiles. In step 710, the profile set creation system, based on the first number of profiles, either generates an interest alert notifying the target profile of the indication of interest (step 712), or receives a second a second set of hints (step 714). For example, an interest alert engine can generate the interest alert, or the communication engine can receive the second set of hints.

In a specific implementation, the profile set creation system can notify the user of the number of matching profiles, and the user can determine if additional hints are required. Further, the profile set creation system can compare the number of matches to a threshold value to make the determination (e.g., without user input).

In step 716, the profile set creation system generates a second profile filter based on the second set of hints. For example, the profile filter engine can generate the second profile filter. In step 718, the profile set creation system filters the plurality of profiles using the second profile filter, which creates a second set of profiles. For example, the profile filter engine can filter the profiles. In step 720, the profile set creation system can calculate a second number of profiles in the second set of profiles. For example, the profile filter engine can calculate the second number of profiles. In step 722, the profile set creation system, based on the second number of profiles, can either generate an interest alert (step 724) or request additional hints, e.g., repeating steps 714-722. In various implementation, steps 714-722 can be repeated until a desired number of profiles is achieved (e.g., 50).

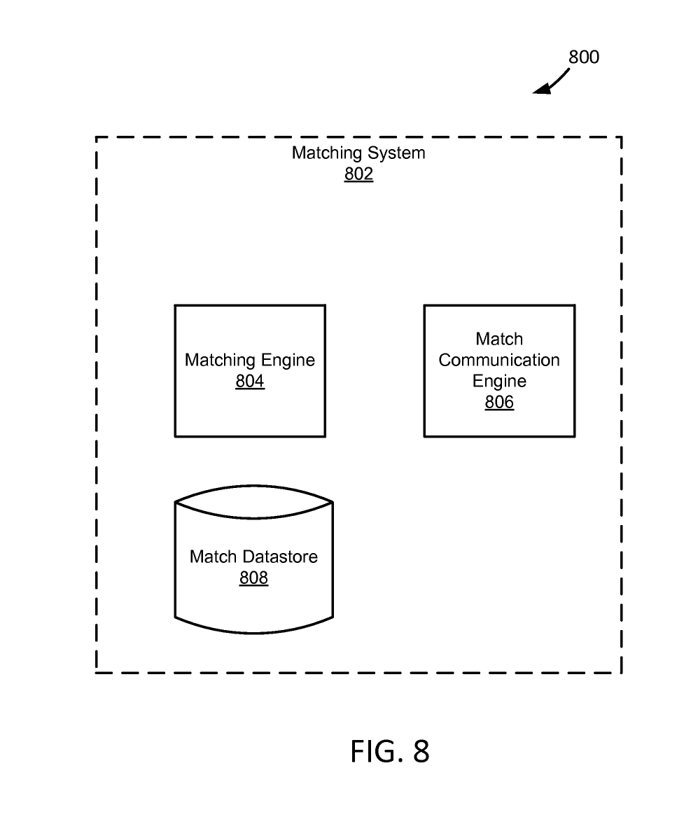

FIG. 8 shows a block diagram of an example matching system 802. The example matching system 802 includes a matching engine 804, a match communication engine 806, and a match datastore 808.

In the example of FIG. 8, the matching engine 804 functions to determine whether a match exists between a user and a target profile, as discussed above. In a specific implementation, the matching engine 804 can additionally determine a probability that a particular set of hints will result in a successful match with an associated target profile. For example, the matching engine 804 can compare the hints to match preferences associated with the target profile. Match preferences can be based on, for example, one or more profile attributes the target profile is seeking in a match (e.g., a single male attending Princeton University). Depending on a difference between the hints and the match preferences, the matching engine can predict a probability of match success (e.g., 70%).

In various implementations, particular profile attributes can be weighted and/or otherwise tuned. For example, particular profile attributes (e.g., gender, age) can be weighted more heavily than other profile attribute (e.g., class year). Profile attribute weighting can either be performed manually (e.g., by an administrator), and/or automatically. For example, the matching engine 804 can gather match data related to successful and unsuccessful matches, and the matching engine 804 can perform statistical analyses (e.g., regression analysis, genetic algorithms, neural networks, finite state machines) on the match data to determine which profile attributes are “indicator” profile attributes, e.g., profile attributes that more heavily influence match success rates than other non-indicator profile attributes.

Similarly, differences between a particular hint (e.g., Princeton University) and a corresponding match preference (e.g., NYU) are not necessarily binary. For example, the matching engine 804 can provide for varying levels of difference between individual hints and corresponding match preferences. For example, a hint that provides “Stanford” to a target profile with a match preference indicating “Boston College” can result in a lower match success probability than a hint that provides “Boston University,” even though both hints are different from the match preference. Accordingly, the matching engine 804 can account for varying degrees in difference between hints and match preferences based on relative geographic, demographic, psychographic, and/or behavioristic differences.

In a specific implementation, the match engine 804 can suggest a set of hints, or modifications to a current set hints, that can improve match probability. For example, if a particular set of hints is based on a set of profile attribute that fail to include any, or too few, indicator profile attributes, the match engine can generate and transmit a data message recommending the user include one or more indicator attributes in an associated set of hints.

In the example of FIG. 8, the match engine 806 can also automatically create a set of hints, or update a set of hints. To continue the previous example, if a particular set of hints is based on a set of profile attributes that fail to include any, or too few, indicator attributes, the match engine 804 can automatically update the hints to include one or more indicator attributes. For example, the match engine 804 can select the one or more indicator attributes from a set of predetermined indicator attributes.

In various implementations, the matching engine 804 can notify a user, and/or suggest hint modifications, if an associated set of hints has a success probability below a particular threshold (e.g., 50%). Similarly, the matching engine 804 can automatically make hint modifications if the success probability is below a particular threshold. In various implementations, the threshold value can be set manually, e.g., by an administrator or the user associated with the set of hints, and/or automatically, e.g., by the matching engine 804.

In the example of FIG. 8, the match communication engine 806 functions to send requests to and receive data from one or a plurality of systems. The match communication engine 806 can send requests to and receive data from a system through a network or a portion of a network. Depending upon implementation-specific or other considerations, the match communication engine 806 can send requests and receive data through a connection, all or a portion of which can be a wireless connection. The match communication engine 806 can request and receive hints, indications of interest, responses from users associated with target profiles, historical and/or statistical data related to successful and/or unsuccessful matches. Received data can be stored in the match datastore 808.

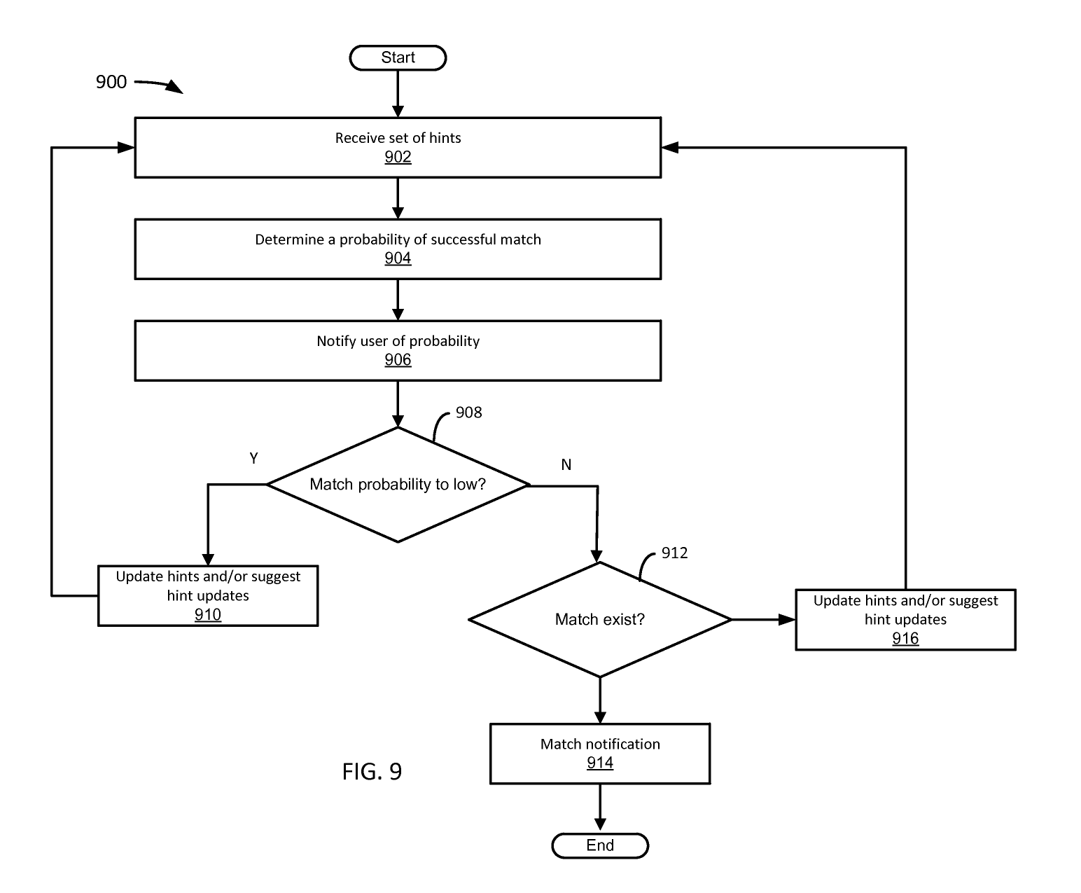

FIG. 9 shows a block diagram of a flowchart of an example method of operation of a matching system.

In step 902, a matching engine can receive a set of hints associated with an indication of interest in a target profile. In step 904, the matching engine can determine a probability of match success between the user that indicated the interest, and the target profile. In step 906, the matching engine can notify the user of the provability, and, if the probability is below a threshold value (step 908), suggest a hint modification, and/or modify the hints (step 910). This can be repeated until the probability of success is equal to or greater than the probability threshold value, and/or the user authorizes the matching engine 804 to proceed. In step 912, the matching engine can determine if a match exists between the user associated with the set of hints and the target profile. In step 914, if a match exists, the matching engine can notify the target profile and the user of the match. In step 916, if a match does not exists, the matching engine can suggest a hint modification and/or automatically modify the hints.

FIG. 10 shows a social network browse window in accordance with example embodiments. Many people like to make new friends and to meet new romantic partners. Some individuals, however, may not wish to reveal their identity without first receiving some indication that the other person is interested. The example embodiments provide a social network whereby a person can give hints to the person of interest about his or her identity, without actually revealing who he or she is. In the examples described herein, the social network may be set up for a particular organization such as a college or university. The social network is not so limited, and the principles described herein may be implemented in other types of social networks or other settings.

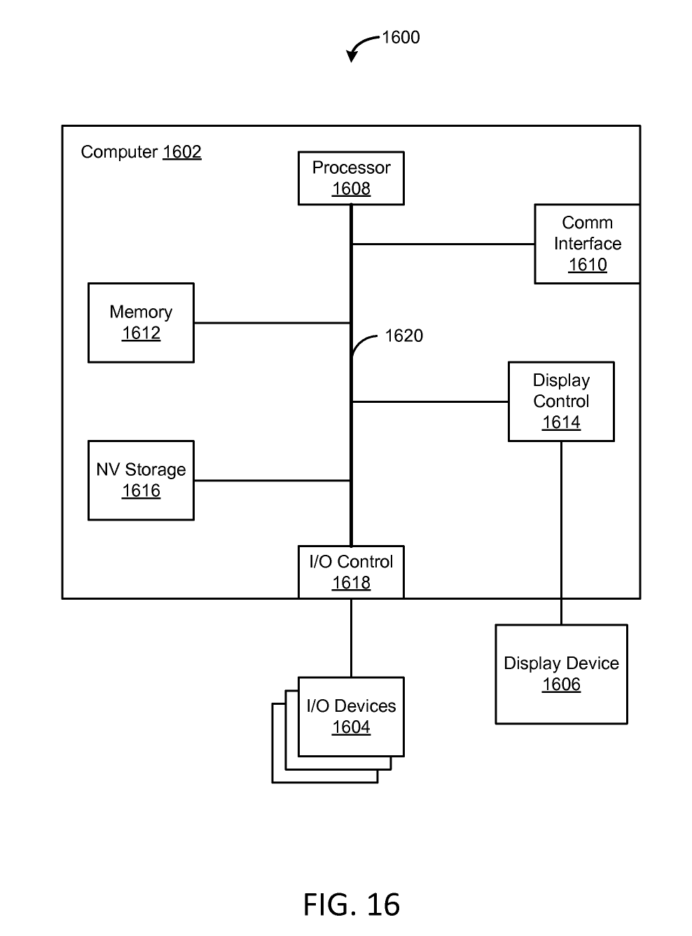

Initially, a user may register with a social network to obtain an account. For example, with brief reference to FIGS. 16-18, a user may use a user device 1601 (e.g., mobile phone, laptop computer, tablet computer, etc.) to connect to one or more servers 1641 implementing the social network via a network (e.g., via the Internet). The server 1641 may serve a registration page (e.g., a webpage or other interface) to the user device 1601 for display to the user. The registration page may prompt the user to input information to create an account. For example, the user may provide information, such as one or more of a name, gender, expected graduation date, major, affiliation (e.g., member of a particular fraternity or sorority, etc.), picture, a description provided by the user (e.g., “about me” profile description), etc. The user may also establish his or her credentials for logging into the account (e.g., username and password, PIN, passcode, etc.).

The user device may communicate the input information to the server 1641 of the social network. The server 1641 may add a database record to a datastore 1825 to store an account that includes the input information. When the user device 1601 subsequently attempts to access the social network, the server 1641 may serve a login page to the user device 1601 for input of the user's credentials (e.g., username and password). The server 1641 may authenticate the credentials to access the user's account and server 1641 may serve a social network browse window for presentation to the user via the user device 1601.

An example of a social network browse window 1000 is depicted in FIG. 10. The browse window 1000 may present other members of the social network to the user so that the user may identify others with which he/she would like to establish a friendship and/or a romantic relationship. The server 1541 may select the other members for presentation in the browse window 1000 randomly, based on searching database records of other members having similar interests to the user, based on input by the user (e.g., name of a member in the social network, any member graduating in 2015, any member majoring in English, any member belonging to a certain fraternity, members that are girls, etc.), and the like. For example, the browse window 100 may prompt the user to input search criteria, and the server 1541 may search the database records based on the search criteria input by the user.

Browse window 1000 may graphically display tiles 1002 associated with other members of the social network. A tile 1002 may display one or more of a photograph of the member, a text description of the user, an image selected by the member (that may or might not show the other member), and the like. In the depicted example, browse window 1000 displays tiles 1002A-F, however, more or fewer tiles may be displayed. Also, browse window 1000 may receive user input for scrolling through the other members (e.g., swipe left, right, up, down, with a finger on a touch display, move a scroll bar using a computer mouse, etc.).

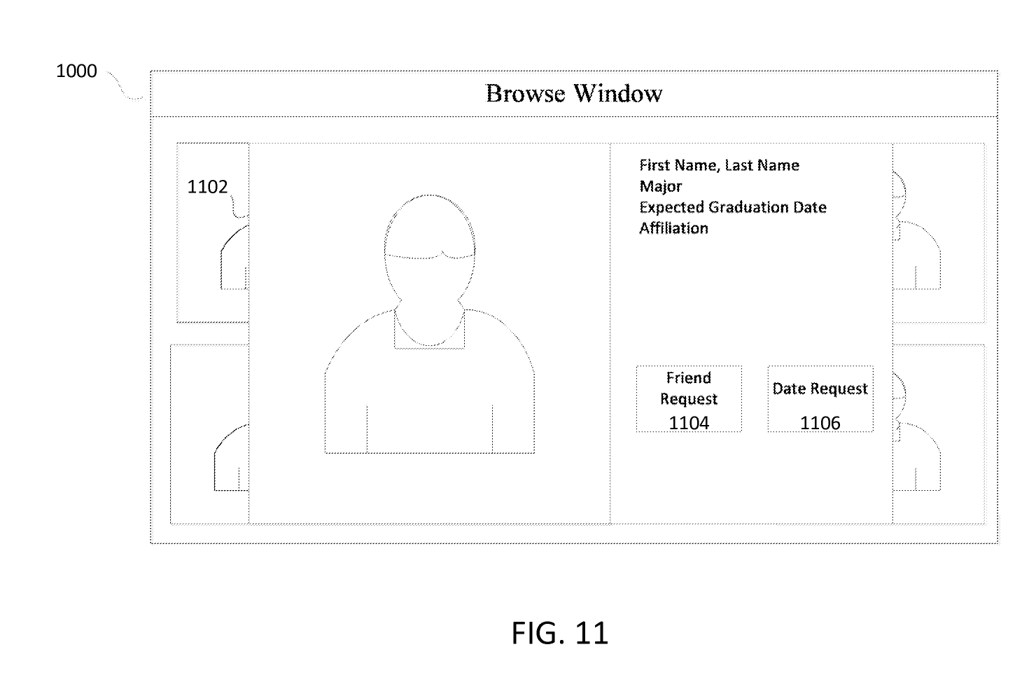

When a user identifies a tile of interest, the user may select the tile (e.g., tap on a tile using a touchscreen, hover above a tile and double-click a computer mouse, and the like). As depicted in FIG. 11, browse window 1000 may enlarge the selected tile and display additional information about the other member. As depicted, selected tile 1002 presents an image of the other member, first and last name, major, expected graduation date, and affiliation (e.g., member of a sorority). Browse window 1000 gives the user the option to send two different types of requests to the other member: a friend request 1104 or a date request 1106. Other types of request may also be sent. In some examples, the user sending any of the requests may remain anonymous (e.g., sending a request won't reveal the user's name or other information to the other member) unless the recipient also sends a reciprocal request of the same type to the user.

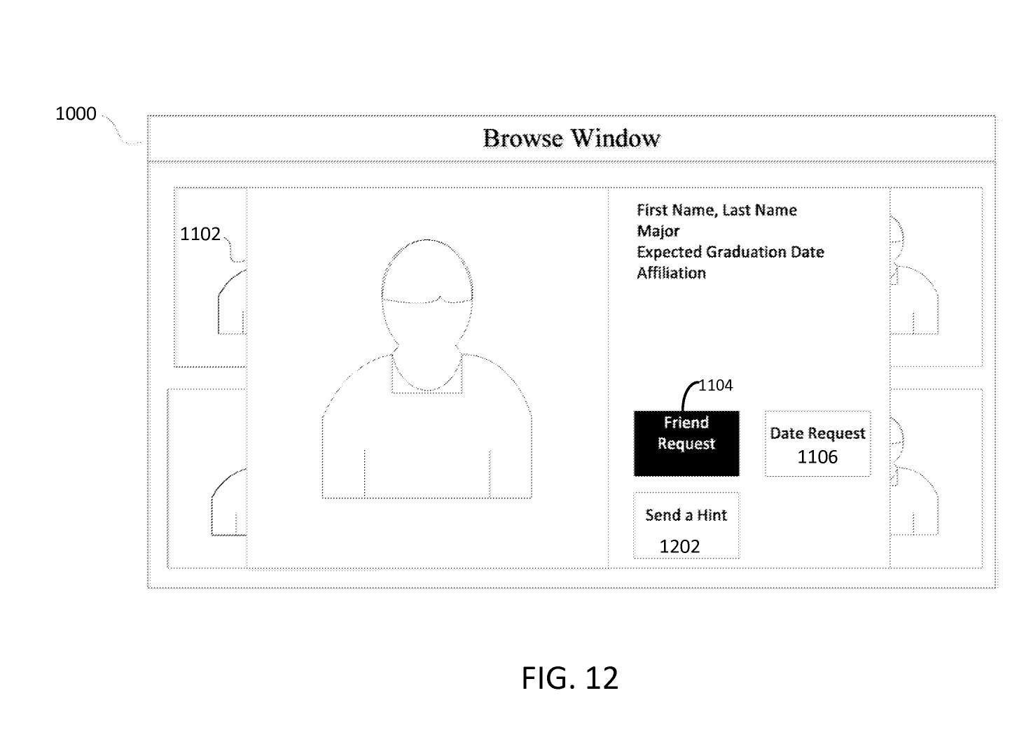

To send a request, the request sending user may select the desired request type to cause the user device 1501 to send the request to the server 1541 of the social network. As depicted in FIG. 12, the request sending user selected to send a friend request 1104. The user device 1501 may update the display of the browse window 1000 to provide an indicator informing the user of his/her selection. For example, friend request 204 may change color, flash, or otherwise draw attention to field 1104. The user device 601 may send the request immediately in response to user selection of field 1104, may prompt the user to confirm his/her selection before sending (e.g., Are you sure you want to send a friend request?), or may prompt the user to send a hint about his/her identity.

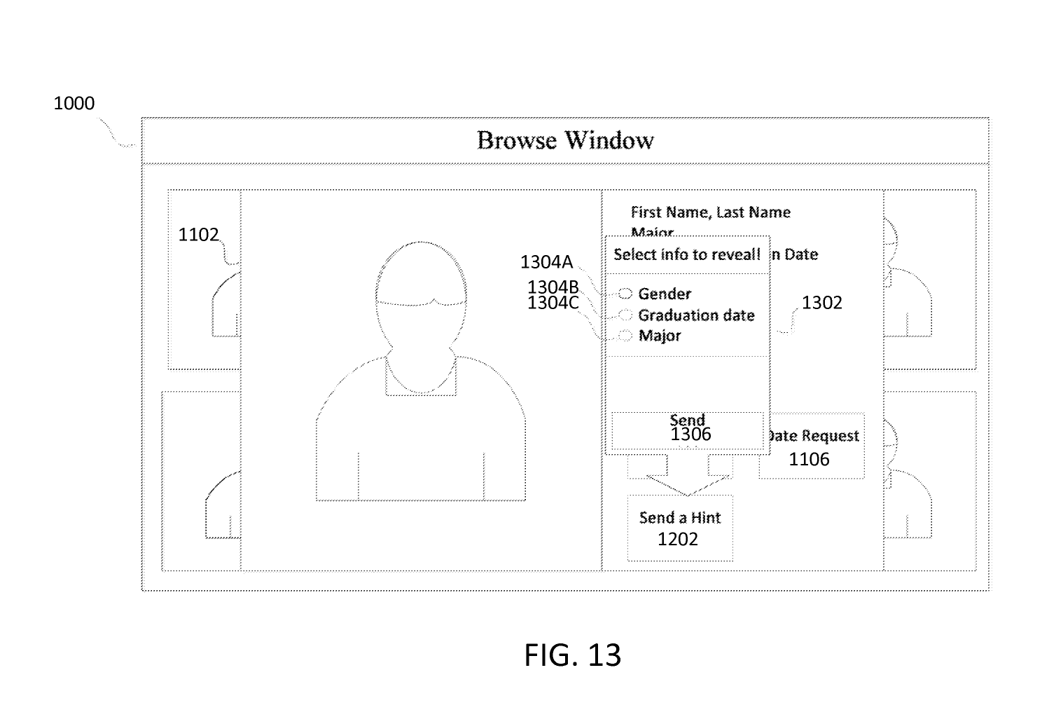

In an example, browse window 1000 may prompt the request sending user whether to send a hint 1202 along with the request. Selecting hint 1202 may permit the user to provide some information about him or herself without revealing exactly who he/she is. A hint may be designed to pique the interest of the recipient member. As depicted in FIG. 13, selecting the “send a hint” field 1202 may cause the browse window 1000 to display a hint field 1302 where the user may customize what hint to send. The hint field 1302 may display information input by the user during registration (or added or updated at a later time) and stored in his/her database record for user selection. For example, hint field 1302 may prompt the user to select one or more of fields 1304A-C respectively corresponding to the user's gender, graduation date, and major. In some examples, the hint field 402 may also permit the user to input text, an image, audio, or video as the hint. When a user selects one or more of fields 1304A-C, the browse window 1000 may update to display the number of matches of other members in the social network who share the same information. Although FIG. 13 only depicts three fields 1304A-C, browse window 1000 may display more or fewer fields.

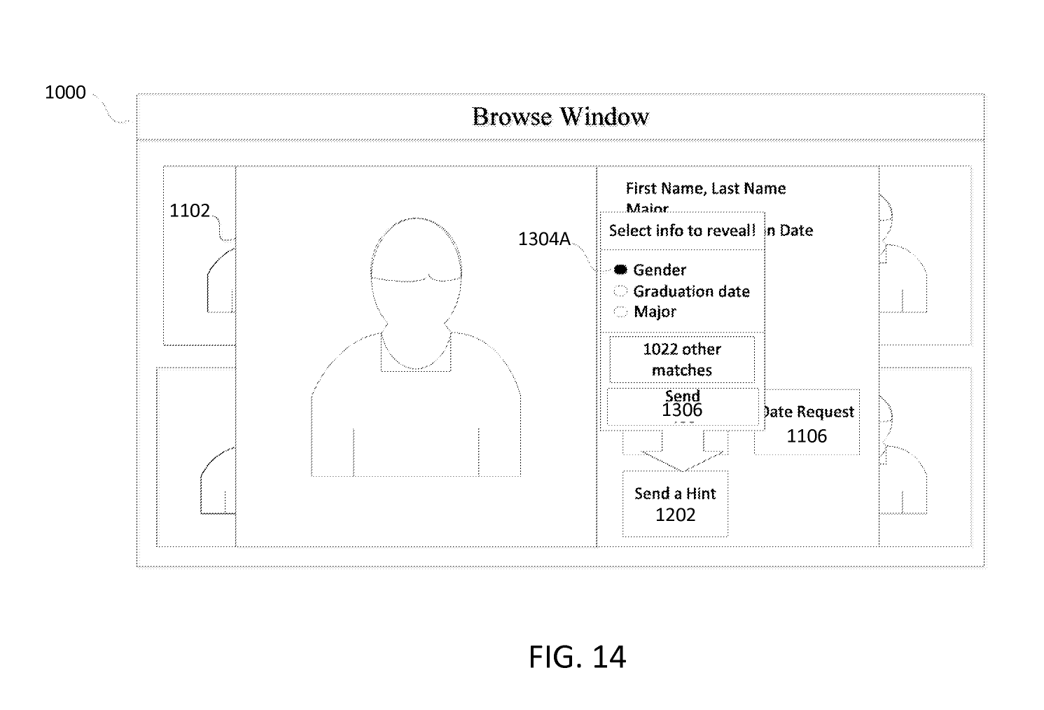

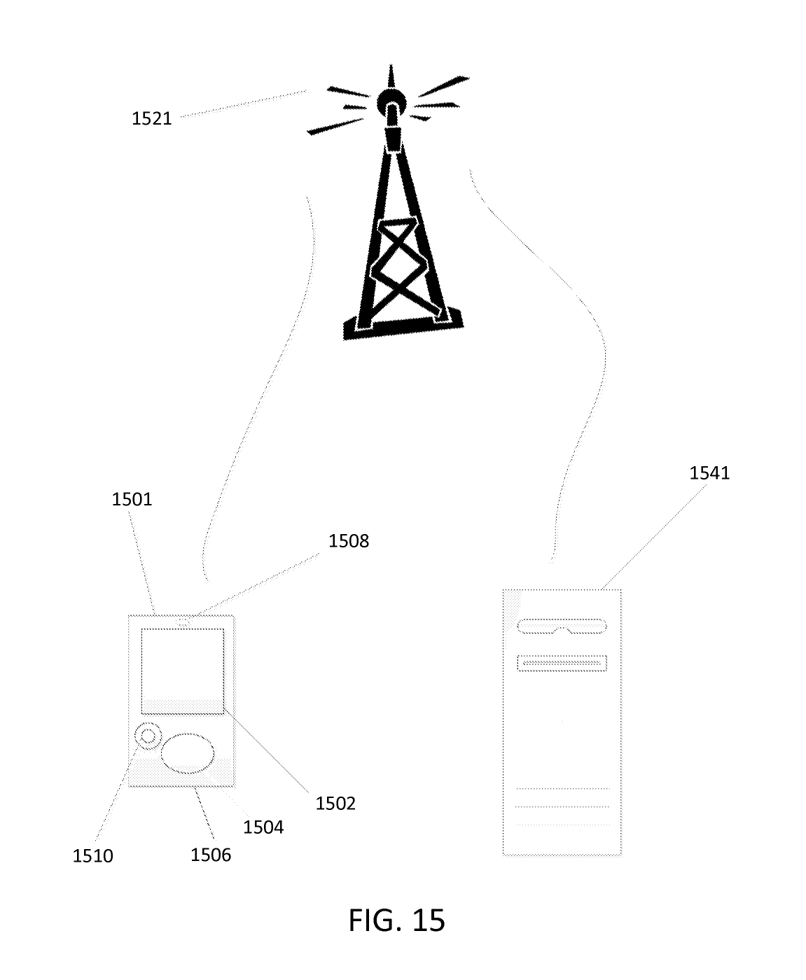

The request sending user may control how descriptive a hint is based on the number of selected fields 1304. Selecting more fields reveals more information, and selecting fewer fields reveals less information about the request sending user. In an example, a user may select the gender field 1304A for revealing his/her gender to the other member. As seen in FIG. 14, browse window 1000 may highlight field 1304A to indicate that the gender field has been selected. In response to the selection, user device 1501 may communicate a query message to the server 1541 of the social network. The server 1541 may search the database records to identify how many other members of the social network share that same feature (e.g., how many other men are members of that social network) and return the results to the user device 1501 for presentation to the user in the browse window 1000. As seen in FIG. 14, there are 1022 other members sharing that information (e.g., 1022 of the social network's members are men).

The request sending user may select various combinations of the fields 1304 to control how many other members match the request sending user's information being revealed. For example, a user may determine that 1022 matches is too many, and may attempt select other fields 1304 in an attempt to reduce the number of other matching members. In some embodiments, the user may be permitted to add additional information which may be used as a hint. For example, a user may have previously indicated they were an economics major, which may result in a large number of potential matchers. The user may be able to add that they also have a Spanish minor which may further limit the total number of matches (e.g., reduce total number of matches from 1022 to 55). The user may be given the option to add this information to his/her public profile or use it just for a particular request. A user is thus given control over how easy or hard it will be for the recipient member to figure out the request sending user's identity. The complexity is due to the number of other members that match the information being revealed. When the user feels that the hint is appropriate (e.g., 70 members or less of the social network match the combination of information to be revealed by the request sending user), the request sending user may select the send field 1306. In response the user device 1501 may communicate the selected request and the hint to the server 1541 of the social network.

The server 1541 may notify a user device 1501 of the recipient about the request at the time the request is sent, the next time the recipient logs onto the social network, or at some other time (e.g., as specified by a request sending user). The recipient's user device 1501 may present the request, identify its type (e.g., friend request, romantic date request, etc.), and optionally any hints provided by the request sending user (e.g., the request sending user is a male, graduating in 2015, and majors in psychology). The recipient's user device 1501 may present a browse window 100 presenting tiles of some or all matching members for the recipient to browse through. By presenting the matching tiles, the recipient user will likely attempt to determine who actually sent the request, thus piquing his/her interest in the request sending user.

The recipient user may use his/her user device 1501 to select one or more tiles presented in the browse window 1000 for sending of requests, similar to the manner described above. The server 1541 may process the requests and, if the recipient user has sent a request of the same type as the request sending user, the server 1541 may reveal the identities of the recipient user and the request sending user to each other and notify each other about the match (e.g., send a notification to the user device of the request sending user and the recipient user). After the identities have been revealed, the server 1541 of the social network may provide an electronic forum permitting the recipient's user device and the request sending user's device to communicate in real-time or by sending discrete messages to one another.

Advantageously, the social network described herein may providing a forum where request sending users may send requests anonymously with the goal of piquing the recipient's interest, and to establish the foundation of a relationship between the request sending user and the recipient.

FIG. 16 shows a block diagram 1600 of an example of a computer system 1602, which can be incorporated into various implementations described in this paper. For example, the hint provisioning systems 104, the profile set creation system 110, the matching system 108, the user device 1501, and the server 1541 may each comprises specific implementation of the computer system 1600. The example of FIG. 16, is intended to illustrate a computer system that can be used as a client computer system, such as a wireless client or a workstation, or a server computer system. In the example of FIG. 16, the computer system 1600 includes a computer 1602, I/O devices 1604, and a display device 1606. The computer 1602 includes a processor 1608, a communications interface 1610, memory 1612, display controller 1614, non-volatile storage 1616, and I/O controller 1618. The computer 1602 can be coupled to or include the I/O devices 1604 and display device 1606.

The computer 1602 interfaces to external systems through the communications interface 1610, which can include a modem or network interface. It will be appreciated that the communications interface 1610 can be considered to be part of the computer system 1600 or a part of the computer 1602. The communications interface 1610 can be an analog modem, ISDN modem, cable modem, token ring interface, satellite transmission interface (e.g. “direct PC”), or other interfaces for coupling a computer system to other computer systems.

The processor 1608 can be, for example, a conventional microprocessor such as an Intel Pentium microprocessor or Motorola power PC microprocessor. The memory 1612 is coupled to the processor 1608 by a bus 1620. The memory 1612 can be Dynamic Random Access Memory (DRAM) and can also include Static RAM (SRAM). The bus 1620 couples the processor 1608 to the memory 530, also to the non-volatile storage 1612, to the display controller 1614, and to the I/O controller 1618.

The I/O devices 1604 can include a keyboard, disk drives, printers, a scanner, and other input and output devices, including a mouse or other pointing device. The display controller 1614 can control in the conventional manner a display on the display device 1606, which can be, for example, a cathode ray tube (CRT) or liquid crystal display (LCD). The display controller 1614 and the I/O controller 1618 can be implemented with conventional well known technology.

The non-volatile storage 1616 is often a magnetic hard disk, an optical disk, or another form of storage for large amounts of data. Some of this data is often written, by a direct memory access process, into memory 1612 during execution of software in the computer 1602. One of skill in the art will immediately recognize that the terms “machine-readable medium” or “computer-readable medium” includes any type of storage device that is accessible by the processor 1608 and also encompasses a carrier wave that encodes a data signal.

The computer system illustrated in FIG. 16 can be used to illustrate many possible computer systems with different architectures. For example, personal computers based on an Intel microprocessor often have multiple buses, one of which can be an I/O bus for the peripherals and one that directly connects the processor 1608 and the memory 1612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1612 for execution by the processor 1608. A Web TV system, which is known in the art, is also considered to be a computer system, but it can lack some of the features shown in FIG. 16, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., steps, modules, blocks, structures, devices, features, etc.) may be variously combined, separated, removed, reordered, and replaced in a manner other than as expressly described and depicted herein.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the implementations is intended to be illustrative, but not limiting, of the scope, which is set forth in the claims recited herein.

We claim:

1. A method comprising:
storing a plurality of profiles of a network, each of the plurality of profiles of the network associated with a plurality of profile attributes;
receiving an interest vector directed from a source profile to a target profile, wherein the source profile and the target profile are two of the plurality of profiles of the network, and a first set of hints associated with the interest vector;
generating a first profile filter based on the first set of hints;
filtering the plurality of profiles of the network using the first profile filter, the filtering creating a first set of profiles including the source profile, each of the profiles in the first set of profiles having profile attributes matching the first set of hints;
calculating a first number of profiles in the first set of profiles;
receiving, based on the first number of profiles, a second set of hints associated with the interest vector, at least a portion of the second set of hints being different from the first set of hints;
generating a second profile filter based on the second set of hints;
filtering the plurality of profiles of the network using the second profile filter, the filtering creating a second set of profiles including the source profile;
calculating a second number of profiles in the second set of profiles, the second number of profiles being different from the first number of profiles; and
generating based on the second number of profiles, an interest alert, the interest alert including data sufficient to directly or indirectly identify the source profile and configured to notify the target profile about the interest vector.

2. The method of claim 1, wherein the interest vector is defined in part by the source profile as an initial point of the interest vector.

3. The method of claim 2, wherein the interest vector is a first interest vector, and wherein the initial point of the interest vector remains hidden after the target profile is notified about the interest vector unless and until a second interest vector exists with the target profile as a second initial point of the second interest vector, the source profile as a second terminal point of the second interest vector, and the first interest vector and the second interest vector have overlapping associated interest types.

4. The method of claim 1, wherein the interest vector is defined in part by the target profile as a terminal point of the interest vector.

5. The method of claim 1, wherein the interest vector includes an interest type selected from a predetermined plurality of interest types by a user associated with the source profile.

6. The method of claim 1, wherein at least one of the first set of hints is selected by a user associated with the source profile.

7. The method of claim 1, wherein at least one of the second set of hints is selected by a user associated with the source profile.

8. The method of claim 1, wherein at least one of the first set of hints is based on a predetermined set of profile attributes associated with the target profile.

9. The method of claim 1, wherein at least one of the second set of hints is based on a predetermined set of profile attributes associated with the target profile.

10. The method of claim 1, further comprising comparing the first number of profiles with a threshold interest alert notification value, wherein the second set of hints are received and the second filter is generated in response to the comparison.

11. The method of claim 1, further comprising comparing the second number of profiles with a threshold interest alert notification value, wherein the interest alert is generated in response to the comparison.

12. A system comprising:
a profile datastore configured to store a plurality of profiles of a network, each of the profiles associated with a plurality of profile attributes;
a profile filter engine configured to:
(i) receive an interest vector directed from a source profile to a target profile, wherein the source profile and the target profile are two of the plurality of profiles of the network, and a first set of hints associated with the interest vector
(ii) generate a first profile filter based on the first set of hints,
(iii) filter the plurality of profiles of the network using the first profile filter, the filtering creating a first set of profiles including the source profile, each of the profiles in the first set of profiles having profile attributes matching the first set of hints,
(iv) calculate a first number of profiles in the first set of profiles,
(v) receive, based on the first number of profiles, a second set of hints associated with the interest vector, at least a portion of the second set of hints being different from the first set of hints;
(vi) generate a second profile filter based on the second set of hints;
(vii) filter the plurality of profiles of the network using the second profile filter, the filtering creating a second set of profiles including the source profile; and
(viii) calculate a second number of profiles in the second set of profiles, the second number of profiles being different from the first number of profiles;
an interest alert engine configured to generate based on the second number of profiles, an interest alert, the interest alert including data sufficient to directly or indirectly identify the source profile and configured to notify the target profile about the interest vector.

13. The system of claim 12, wherein the interest vector is defined in part by the source profile as an initial point of the interest vector.

14. The system of claim 13, wherein the interest vector is a first interest vector, and wherein the initial point of the interest vector remains hidden after the target profile is notified about the interest vector unless and until a second interest vector exists with the target profile as a second initial point of the second interest vector, the source profile as a second terminal point of the second interest vector, and the first interest vector and the second interest vector have overlapping associated interest types.

15. The system of claim 12, wherein the interest vector is defined in part by the target profile as a terminal point of the interest vector.

16. The system of claim 12, wherein the interest vector includes an interest type selected from a predetermined plurality of interest types by a user associated with the source profile.

17. The system of claim 12, wherein at least one of the first set of hints is selected by a user associated with the source profile.

18. The system of claim 12, wherein at least one of the second set of hints is selected by a user associated with the source profile.

19. The system of claim 12, wherein at least one of the first set of hints is based on a predetermined set of profile attributes associated with the target profile.

20. The system of claim 12, wherein at least one of the second set of hints is based on a predetermined set of profile attributes associated with the target profile.

21. The system of claim 12, wherein the profile filter engine is further configured to compare the first number of profiles with a threshold interest alert notification value, wherein the second set of hints are received and the second filter is generated in response to the comparison.

22. The system of claim 12, wherein the profile filter engine is further configured to compare the second number of profiles with a threshold interest alert notification value, and the interest alert engine is further configured to generate the interest alert in response to the comparison.

23. A non-transitory computer readable medium comprising executable instructions, the instructions being executable by a processor to perform a method, the method comprising:
storing a plurality of profiles of a network, each of the plurality of profiles of the network associated with a plurality of profile attributes;
receiving an interest vector directed from a source profile to a target profile, wherein the source profile and the target profile are two of the plurality of profiles of the network, and a first set of hints associated with the interest vector;
generating a first profile filter based on the first set of hints;
filtering the plurality of profiles of the network using the first profile filter, the filtering creating a first set of profiles including the source profile, each of the profiles in the first set of profiles having profile attributes matching the first set of hints;
calculating a first number of profiles in the first set of profiles;
receiving, based on the first number of profiles, a second set of hints associated with the interest vector, at least a portion of the second set of hints being different from the first set of hints;
generating a second profile filter based on the second set of hints;
filtering the plurality of profiles of the network using the second profile filter, the filtering creating a second set of profiles including the source profile;
calculating a second number of profiles in the second set of profiles, the second number of profiles being different from the first number of profiles; and
generating based on the second number of profiles, an interest alert, the interest alert including data sufficient to directly or indirectly identify the source profile and configured to notify the target profile about the interest vector.

24. A system comprising:
means for storing a plurality of profiles of a network, each of the plurality of profiles of the network associated with a plurality of profile attributes;
means for receiving an interest vector directed from a source profile to a target profile, wherein the source profile and the target profile are two of the plurality of profiles of the network, and a first set of hints associated with the interest vector;
means for generating a first profile filter based on the first set of hints;
means for filtering the plurality of profiles of the network using the first profile filter, the filtering creating a first set of profiles including the source profile, each of the profiles in the first set of profiles having profile attributes matching the first set of hints;
means for calculating a first number of profiles in the first set of profiles;
means for receiving, based on the first number of profiles, a second set of hints associated with the interest vector, at least a portion of the second set of hints being different from the first set of hints;
means for generating a second profile filter based on the second set of hints;
means for filtering the plurality of profiles of the network using the second profile filter, the filtering creating a second set of profiles including the source profile;
means for calculating a second number of profiles in the second set of profiles, the second number of profiles being different from the first number of profiles; and
means for generating based on the second number of profiles, an interest alert, the interest alert including data sufficient to directly or indirectly identify the source profile and configured to notify the target profile about the interest vector.
